(19) United States
(12) Patent Application Publication
(10) Pub. No.: US 2014/0346687 A1
(43) Pub. Date: Nov. 27, 2014

(54) ELECTRICAL DEVICE FOR CIRCULATING AIR

(71) Applicant: Steven Rudolph Wozniak, Evansville, IN (US)

(72) Inventor: Steven Rudolph Wozniak, Evansville, IN (US)

(73) Assignee: Steven Rudolph Wozniak, Evansville, IN (US)

(21) Appl. No.: 13/898,478

(22) Filed: May 21, 2013

(51) Int. Cl. F04D 29/64; B05B 3/02

(52) U.S. Cl. CPC F04D 29/646; B05B 3/02
USPC 261/20; 415/60

(57) ABSTRACT

An electrical device for circulating air is provided. The electrical device includes a pole attached to a fixed support, a coupling attached to the pole and plurality of fans is attached to the coupling. The plurality of fans receives power from a power source through electrical cables. Further, the electrical device includes a battery for providing power to the fans and thus making it a portable device. The electrical device may be placed on any surface in any area. The single coupling for attaching the plurality of fans makes it easier to assemble or disassemble the parts of the electrical device.

### BACKGROUND OF THE INVENTION

1. Field of the Invention

The present invention generally relates to an electrical device used for circulating air, and more particularly relates to an electrical device having plurality of fans attached to a single coupling for circulating air.

2. Description of Related Art

It is well known in the art that electric fans are used by humans to cool themselves. Such fans are generally mounted on a table, a wall or on floor. These electric fans contain a motor that rotates the blades of the fan on receiving power. Electric fans are liked by the customers as they are less expensive in comparison to the air conditioners. Electrical fans are also portable and can be used in any ground but with an alternating current supply. Recently, there has been an increase in the sales of multiple fans attached to a pole for covering more area for increasing the effectiveness of cooling.

It is also known in the art that multiple fans are attached to the pole at different positions in order to circulate air. However, these electric fans have a very complex assembly and take a lot of time to disassemble them. Mostly, electric fans are connected to a pole through different couplings. Therefore, there is a need of an electrical device which provides allows all the fans to attach at a single coupling and thus making the process of assembly and disassembly easy. Furthermore, the electrical device should operate on a battery.

### SUMMARY OF THE INVENTION

In accordance with the teachings of the present invention an electrical device for circulating air is provided.

An object of the present invention is to provide an electrical device including a pole attached to a fixed support, a coupling mounted around the pole and plurality of fans attached to the coupling.

Another object of the present invention is to provide an electrical device having electrical cables attached to attach plurality of fans to a power source. The power source may be either an alternating current or direct current source like a battery.

Another object of the present invention is to provide the coupling with a hollow arm mounted around the pole, plurality of first connecting members and plurality of second connecting members interconnected with each other. Further, the plurality of fans is connected to the second connecting members.

Another object of the present invention is to attach the pole with either a table or wedge or base or plate or floor or wall or roof or rafter or ceiling or stabilizing device or structural support or a tripod stand. Further, the electrical device to have four fans to circulate air in all direction.

These and other features, aspects, and advantages of the present invention will become better understood with reference to the following description. This summary is provided to produce a selection of concepts in a simplified form. This summary is not intended to identify key features or claimed features of the present invention, nor is it intended to be used to limit the scope of the claimed present invention.

### BRIEF DESCRIPTION OF DRAWINGS

FIG. 1 illustrates an exploded view of the electrical device for circulating air in accordance with a preferred embodiment of the present invention;

FIG. 2 illustrates another exploded view of the electrical device connected to a battery in accordance with another preferred embodiment of the present invention; and

FIG. 3 illustrates another exploded view of the electrical device attached to a fixed support in accordance with another preferred embodiment of the present invention; and

FIG. 4 illustrates a perspective view of the electrical device in another embodiment of the present invention; and

FIG. 5 illustrates another exploded view of the electrical device attached to a tripod stand.

### DETAILED DESCRIPTION OF DRAWINGS

While this technology is illustrated and described in a preferred embodiment, the electrical device may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

Reference will now be made in detail to several embodiments of the invention which are illustrated in the accompanying drawings. Wherever feasible and convenient, the same reference numerals are used in the figures and the description to refer to the same or like parts. The drawings are in a simplified form and not to precise scale. For purposes of convenience and clarity only, directional terms, such as top, bottom, left, right, up, down, over, above, below, beneath, rear, and front may be used with respect to the accompanying drawings. These and similar directional terms should not be strictly construed to limit the scope of the invention. In addition, words such as attached, affixed, coupled, connected and similar terms with their inflectional morphemes are used interchangeably, unless the difference is noted or made otherwise clear from the context. These words and expressions do not necessarily signify direct connections, but include connections through mediate components and devices.

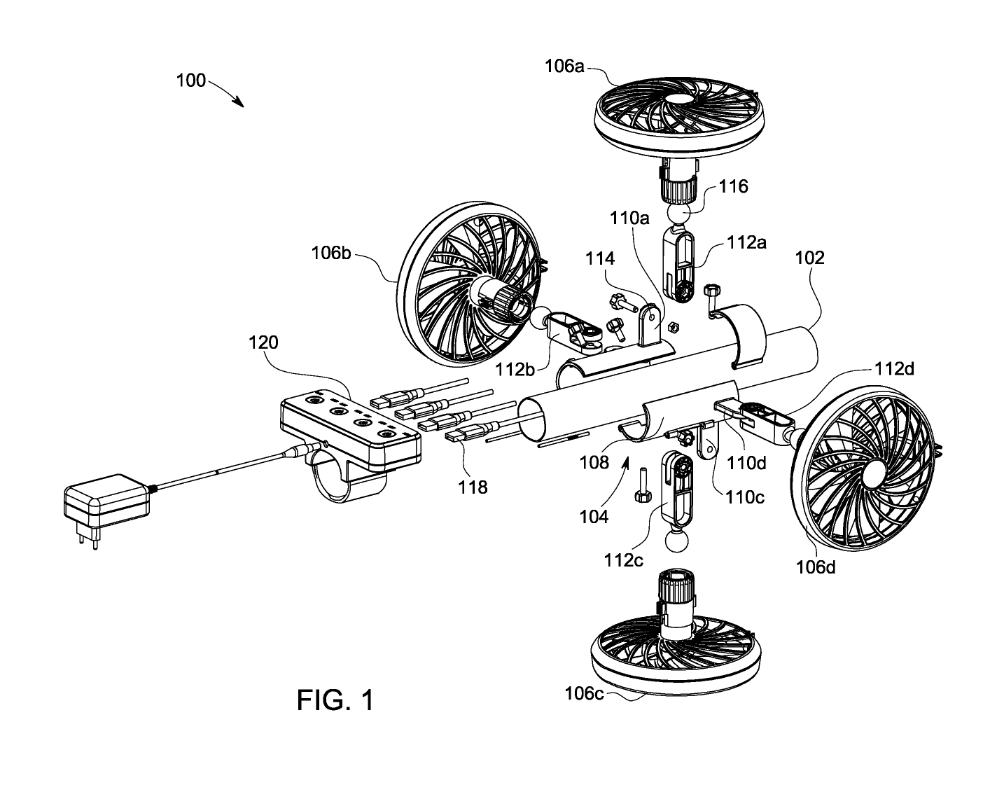

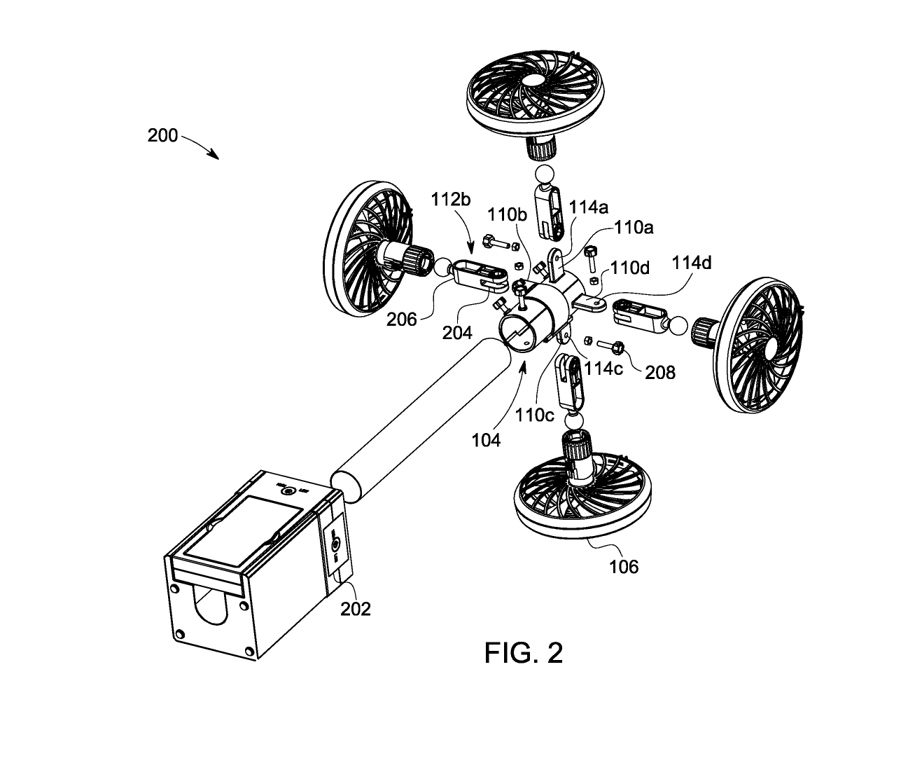

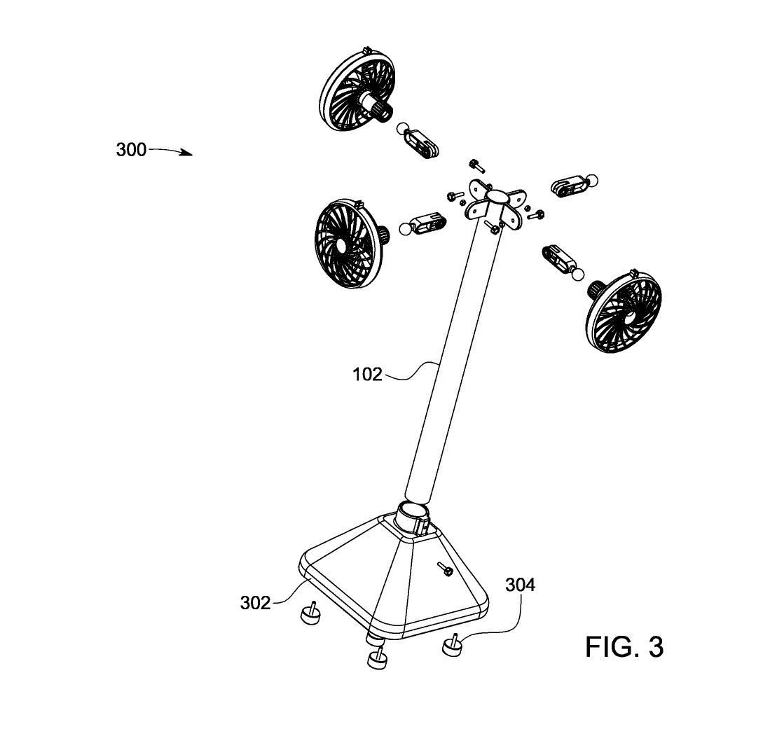

FIG. 1 illustrates an exploded view of the electrical device 100 for circulating air. The electrical device 100 includes a pole 102, a coupling 104 and plurality of fans 106, such as fan 106a, fan 106b, fan 106c and fan 106d. The pole 102 is attached to a fixed support (not shown in FIG. 1). The attachment of pole 102 with the fixed support is shown in FIG. 3 of the present invention. The coupling 104 includes a hollow tubular arm 108, plurality of first connecting members 110, such as 110a, 110b (not visible in FIG. 1), 110c, 110d and plurality of second connecting members 112 such as 112a, 112b, 112c, 112d. The first connecting member 110b is shown in FIG. 2 of the present invention.

The hollow tubular arm 108 is mounted around the pole 102. In a preferred embodiment of the present invention, the hollow tubular arm 108 is detachably attached to the pole 102. The shape of hollow tubular arm 108 is cylindrical; however it will be apparent to those skilled in the art that any other shape for the hollow tubular arm 108 may be envisioned without deviating from the scope of the present invention.

The plurality of first connecting members 110 are projected transversely from the hollow tubular arm 108. The plurality of second connecting members 112 such as 112a, 112b, 112c, 112d includes a first end and a second end. The first end and the second end are explained in detailed in conjunction with FIG. 2 of the present invention. The plurality of first connecting members 110 is detachably attached to respective each of the plurality of second connecting members 112. It is to be noted that various shapes and forms of the first connecting members 110 and the second connecting members 112 may be envisioned without deviating from the scope of the present invention. The attachment of the first connecting members 110 with the second connecting members 112 is explained in detailed in conjunction with FIG. 2 of the present invention. Each of the plurality of second end of plurality of second connecting members 112 further includes a locking unit 116.

The plurality of fans 106 are detachably attached to respective each of the locking units 116. The fans 106 generally include an electric motor that rotates the blades of the fans 106 and thus circulate the air. In a preferred embodiment of the present invention, the locking unit 116 is ball socket locking unit; however it will be readily apparent to those skilled in the art that various other forms of locking unit 116 may be envisioned without deviating from the scope of the present invention.

In another preferred embodiment of the present invention, the electrical device 100 includes one or more attachment means for detachably attaching plurality of first connecting members 110 with plurality of second connecting members 112. The one or more attachment means are explained in detailed in conjunction with FIG. 2 of the present invention.

In another preferred embodiment of the present invention, the electrical device 100 further includes plurality of cables 118 for connecting each of said plurality of fans 116 to a power source. In a preferred embodiment of the present invention, the plurality of electric cables 118 is USB cables. However, it would be readily apparent to those skilled in the art that various other means for providing power to the fans may be used without deviating from the scope of the present invention. Examples of power source include an alternating current source and direct current such as a battery. In another preferred embodiment of the present invention, the electrical device 100 further includes a control box 120 for connecting the plurality of electrical cables 118 to said power source at a single point. As shown in FIG. 1, the control box 120 is connected to a power source through an adapter. The control box 120 provides power to the plurality of fans 106 through the plurality of electrical cables 118.

In a preferred embodiment of the present invention, the electrical cables 118 generally run parallel to the pole 102 in the vertical space between the coupling 104 and interconnect plurality of fans 106.

In another preferred embodiment of the present invention, the electrical cables 118 generally run inside the pole 102 in the vertical space between the coupling 104 and interconnect plurality of fans 106.

FIG. 2 illustrates an exploded view of the electrical device 200 connected to a battery 202 in accordance with a preferred embodiment of the present invention. In a preferred embodiment of the present invention, the electrical device 200 includes a power source, such as battery 202. The battery 202 provides power for operation of the plurality of fans 106. In a preferred embodiment of the present invention, the battery 202 is a lithium battery; however it will be readily apparent to those skilled in the art that various other forms of the battery 202 may be used without deviating from the scope of the present invention.

With reference to FIG. 1, each of the first connecting members 110 such as 110a, 110b, 110c and 110d includes an indent 114 such as 114a, 114b (not visible in FIG. 2), 114c and 114d. Each of the second connecting members 112 includes a first end 204 and a second end 206. In another preferred embodiment, the electrical device 200 includes plurality of attachment means 208. Each of the plurality of first connecting members 110 is attached to the first end 204 of each of the second connecting member 112 through plurality of attachment means 208. Examples of plurality of attachment means 208 includes but not limited to nuts, bolts, screws etc. Thus, a single coupling 104 provides a convenient way to attach plurality of fans. Further, the single coupling 104 provides a convenient way for assembly and disassembly of the plurality of fans 106.

FIG. 3 illustrates another exploded view of the electrical device 300 attached to a fixed support 302. Examples of the fixed support include but not limited to wall, table, floor, stabilizing device, structural support, tripod stand, wedge etc. However it will be known to those skilled in the art that many other possible variations of the fixed support 302 may be envisioned without deviating from the scope of the present invention. In a preferred embodiment of the present invention the electrical device 300 is attached to wedge 302. The wedge 302 is provided with plurality of stabilizers 304 for stability of the electrical device 300. The shape of pole 102 is a hollow cylindrical; however it will be apparent to those skilled in the art that any other shape for the pole 102 may be envisioned without deviating from the scope of the present invention.

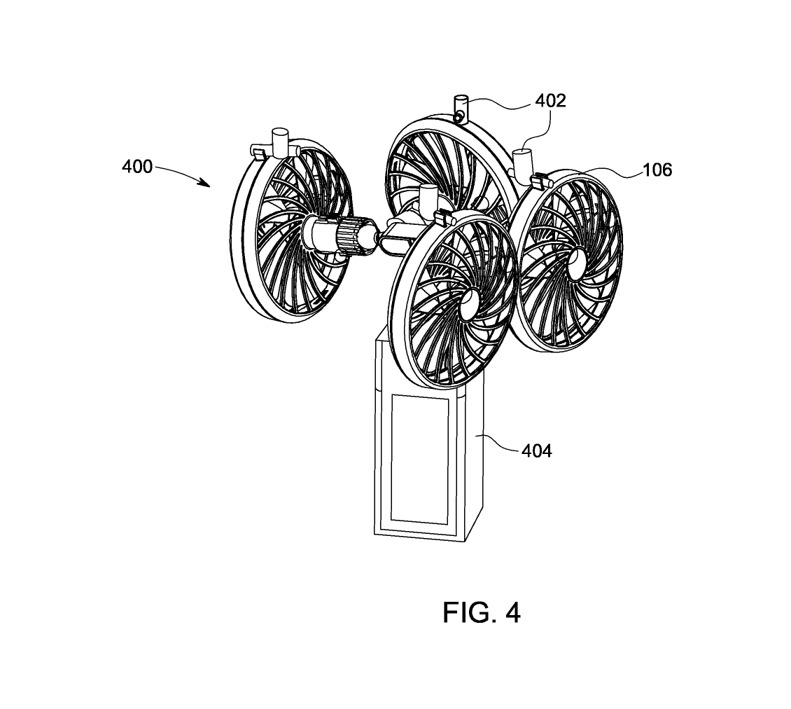

FIG. 4 illustrates a perspective view of the electrical device 400 in another embodiment of the present invention. The electrical device 400 further includes plurality of misting valves and nozzles 402 attached on each of the plurality of fans 106. In a preferred embodiment of the present invention, each of the plurality of misting valves and nozzles 402 receives a water pipe for releasing water during the operation of the fan 106. Thus, circulation of air and water in an area results in the decrease of the temperature. In another preferred embodiment of the present invention, the electrical device 400 is attached to a rectangle table 404. Thus, the electrical device 400 is portable and may be operated at any place. In another preferred embodiment of the present invention, the rectangle table 404 with a storage tank to store water and a pump may be connected to circulate water from the storage tank to the misting valves and nozzles 402.

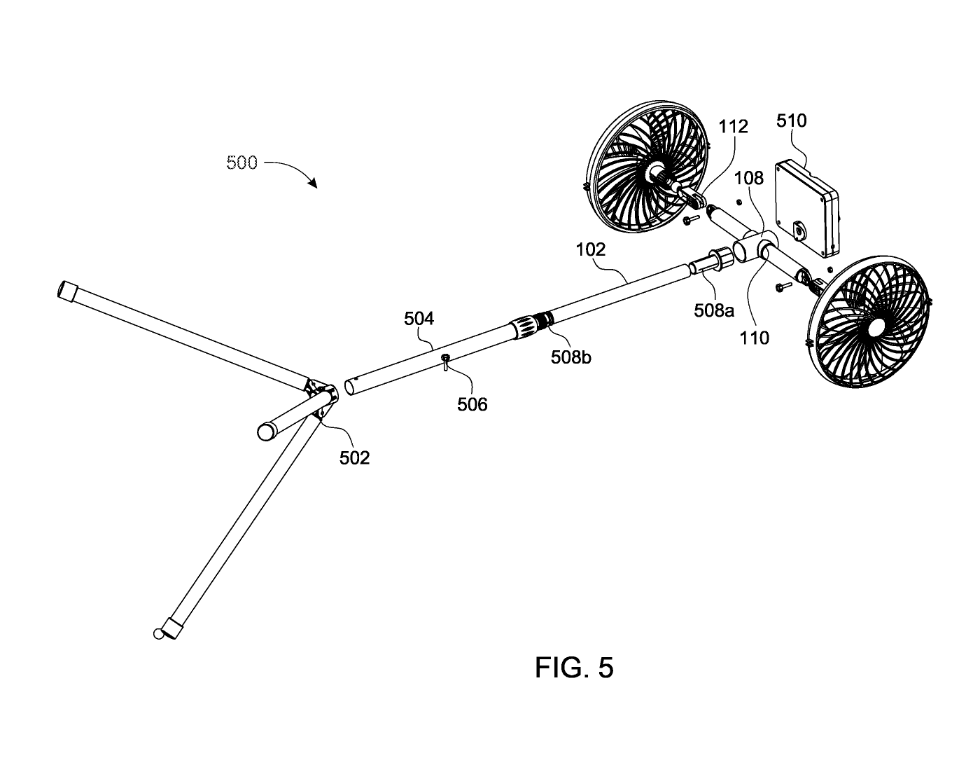

FIG. 5 illustrates another exploded view of the electrical device 500 attached to a tripod stand 502. The tripod stand includes a rod 504. In a preferred embodiment of the present invention, the rod 504 may be a telescopic arm and the length may be adjusted through a lever 506. With reference from FIG. 1, the pole 102 is attached to the rod 504. The hollow arm 108 is attached to the pole 102. The electrical device 500 further includes plurality of stopper sleeves 508 such as 508a and 508b. The stopper sleeve 508a for connecting the hollow arm 108 with the tube 102. The stopper sleeve 508b for connecting the tube 102 with the rod 504. Further, each of the first connecting members 110 is connected to the each of the second connecting members 112. The electrical device 500 further includes a battery pack holder 510 attached to the hollow arm 108. The battery pack holder 510 allows attaching of a battery.

The present invention offers various advantages. The present invention allows the assembly and disassembly of the electrical device from one coupling. The present invention is portable and may be operated through a lithium battery at any place. The present invention further circulates in all direction, as a single coupling is used to attach all the fans and preferably four.

The foregoing discussion discloses and describes merely exemplary embodiments of the present invention. One skilled in the art will readily recognize from such discussion and from the accompanying drawings that various changes, modifications and variations may be made therein without departing from the spirit and scope of the invention.

1. An electrical device for circulating air comprising:
a pole attached to a fixed support;
a coupling comprising:
a hollow tubular arm attached to said pole;
plurality of first connecting members projected transversely from said hollow tubular arm, and
plurality of second connecting members, wherein each of said plurality of second connecting members comprising a first end and a second end, said first end detachably attached to respective each of said plurality of first connecting members, wherein each of said second end comprising a locking unit; and
plurality of fans to circulate air, wherein each of said plurality of fans detachably attached to respective each of said locking unit.

2. The electrical device according to claim 1 further comprising plurality of electrical cables for connecting each of said plurality of fans to a power source.

3. The electrical device according to claim 1 further comprising plurality of attachment means to detachably attach said plurality of first connecting members with said second plurality of second connecting members.

4. The electrical device according to claim 2 further comprising a control box for connecting plurality of electrical cables to said power source at a single point.

5. The electrical device according to claim 1 wherein each of said second connecting members comprising a ball-socket locking unit.

6. The electrical device according to claim 2 wherein said electrical cables comprising USB cables and adapters.

7. The electrical device according to claim 2 wherein said power source is a battery.

8. The electrical device according to claim 1 further comprising plurality of misting valves and nozzles attached to each of said plurality of fans, said plurality of misting valves and nozzles to provide facility of receiving a water pipe for releasing water.

9. An electrical device for circulating air comprising:
a pole attached to a fixed support;
a coupling attached to said pole, said coupling comprising:
a hollow tubular arm mounted around said pole;
plurality of first connecting members projected transversely from said hollow tubular arm, wherein each of said first connecting members comprising at least one indent in each of said first connecting members; and
plurality of second connecting members, wherein each of said plurality of second connecting members comprising a first end and a second end, said first end detachably attached to respective each of said plurality of first connecting members through each respective indent, wherein each of said second end comprising a locking unit;
plurality of fans to circulate air, wherein each of said plurality of fans detachably attached to respective each of said locking unit;
a power source for providing power to each of said plurality of fans; and
plurality of electrical cables for connecting each of said plurality of fans to said power source.

10. The electrical device according to claim 9 further comprising plurality of attachment means to detachably attach said plurality of first connecting members with said second plurality of second connecting members.

11. The electrical device according to claim 9 further comprising a control box for connecting plurality of electrical cables to said power source at a single point.

12. The electrical device according to claim 9 wherein said locking unit is a ball socket locking unit.

13. The electrical device according to claim 9 wherein said electrical cables comprising USB cables and adapters.

14. The electrical device according to claim 9 wherein said power source comprising a battery.

15. The electrical device according to claim 9 further comprising plurality of misting valves and nozzles attached to each of said plurality of fans, said plurality of misting valves and nozzles to provide facility of receiving a water pipe for releasing water.
